(19) United States
(12) Patent Application Publication
(10) Pub. No.: US 2005/0087634 A1
(43) Pub. Date: Apr. 28, 2005

(54) Forage distributor

(75) Inventor: Andre Pellerin, Saint-Adrien-de-Ham (CA)

Correspondence Address: ROBIC, CENTRE CDP CAPITAL, 1001, VICTORIA SQUARE - BLOC E - 8TH FLOOR, MONTREAL, QC, H2Z 2B7, CA

(73) Assignee: A PELLERIN & FILS LTEE

(21) Appl. No.: 10/971,052

(22) Filed: Oct. 25, 2004

(30) Foreign Application Priority Data
Oct. 24, 2003 (CA) 2,446,653

(51) Int. Cl. A01C 3/06

(52) U.S. Cl. 239/668; 239/650

(57) ABSTRACT

A forage distributor for delivering of forage to livestock at a controlled rate. The forage distributor has a hopper for receiving forage, with the hopper having a lateral opening in a side wall thereof. The forage distributor also has a rotary mixer and a forage conveyor for carrying the forage towards the lateral opening. A driving mechanism rotates the rotary mixer and moves the forage conveyor towards the lateral opening. Control means are provided for controlling power provided to the driving mechanism to regulate speeds of the rotary mixer and the forage conveyor. The forage distributor also has a moving mechanism operatively connected to the hopper for moving the hopper along a path extending in front of the livestock.

### FIELD OF THE INVENTION

The present invention relates to a forage distributor for repetitive delivering of feeds to cattle or the like.

### BACKGROUND OF THE INVENTION

Cattle and other farm animals are generally confined in indoor or outdoor stalls positioned according to a specific layout depending substantially on the available space and the required accessibility. One usual layout is to have the animals side-by-side in rows separated by passages for feeding and cleaning purposes. At feeding time, the farmer generally deposits individual rations of fodder on the ground or in mangers in front of each animal. This repetitive duty is tedious and time consuming, especially if there are numerous animals to feed.

To solve the above problem, feeding systems were invented for the automation of feed distribution. Among those feeding systems, some comprise an overhead rail with a suspended device passing in front of each animal and which prepares and delivers individual feed rations. Known in the art, there is for example U.S. Pat. No. 5,069,165 (ROUSSEAU) which discloses a livestock feeder system that mixes and prepares a feed mixture for livestock. The system has a main ensilage compartment with a pair of rotary shredders extending one above the other for cutting the ensilage and an endless chain conveyor at its bottom for conveying the ensilage toward a discharge conveyor screw. The system also has a separate secondary compartment section forming a set of secondary compartments, with each being provided with one or two conveyor screws to dispense a substance of its compartment into the discharge screw. However, such system is costly, bulky, often too sophisticated for the needs of average farmers and is not well adapted for distributing forage.

Also known in the art, there is U.S. Pat. No. 5,505,160 (PELLERIN) which discloses a simpler, yet efficient, feed distributing apparatus. This apparatus allows for livestock to eat the fodder directly inside the apparatus and uses gravity to deliver the feed. Although this apparatus accomplishes the object for which it was designed for, it is somewhat difficult to achieve a constant and continuous distribution of forage because it is dependent upon the feeding mood or rate of each animal. Therefore, the forage output debit may vary. Also, it is difficult to ascertain exactly what quantity of forage each animal has ingested.

There is therefore a need for a forage distributor that could be able to provide a more constant and continuous distribution of forage, while at the same time would have a relatively simple design as compared to the known feeder systems.

### SUMMARY OF THE INVENTION

According to the present invention, there is provided a forage distributor for delivering of forage to livestock at a controlled rate, comprising:
a hopper for receiving forage, the hopper having at least one lateral opening in a side wall of the hopper and adjacent to a bottom of the hopper for allowing the forage to exit therefrom;
at least one rotary mixer extending inside of the hopper for guiding the forage towards the at least one lateral opening;
forage conveyor means for carrying the forage towards the at least one lateral opening, the forage conveyor means being positioned below the at least one rotary mixer and adjacent to the bottom of the hopper;
driving means operationally connected to the at least one rotary mixer and the forage conveyor means for rotating the at least one rotary mixer and moving the forage conveyor means towards the at least one lateral opening;
control means for controlling power provided to the driving means to regulate speeds of the at least one rotary mixer and the forage conveyor means; and
moving means operatively connected to the hopper for moving the hopper along a path extending in front of the livestock.

The invention as well as its numerous advantages will be better understood by reading of the following non-restrictive description of preferred embodiments made In reference to the appending drawings.

### BRIEF DESCRIPTION OF THE DRAWINGS

FIG. 1 is a perspective front view of a forage distributor according to a preferred embodiment or the present invention, with a side wall being removed to show internal components thereof.

FIG. 2 is a front elevation view of the forage distributor shown in FIG. 1, with certain gears being removed and showing an anti-clockwise rotation of the gears.

FIG. 3 is another front elevation view of the forage distributor shown in FIG. 1, and showing a clockwise rotation of the gears.

FIG. 4 is back elevation view of the forage distributor shown in FIG. 1.

FIG. 5 is a side elevation view of the forage distributor shown in FIG. 1. FIG. 6 is a back perspective view of the forage distributor shown in FIG. 1, with a back wall being removed to show internal components thereof.

### DETAILED DESCRIPTION OF THE INVENTION

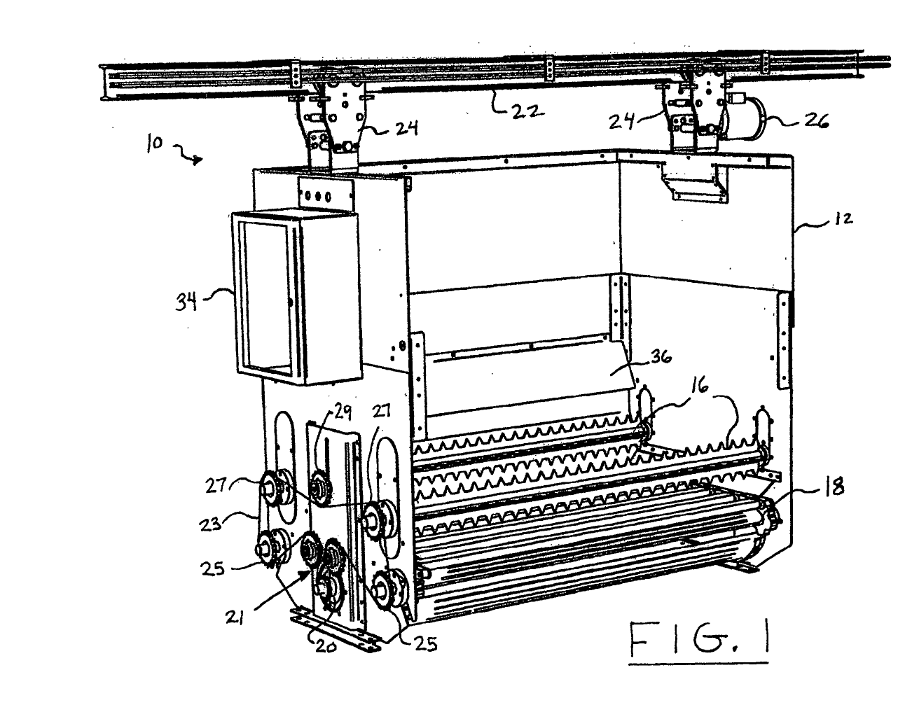

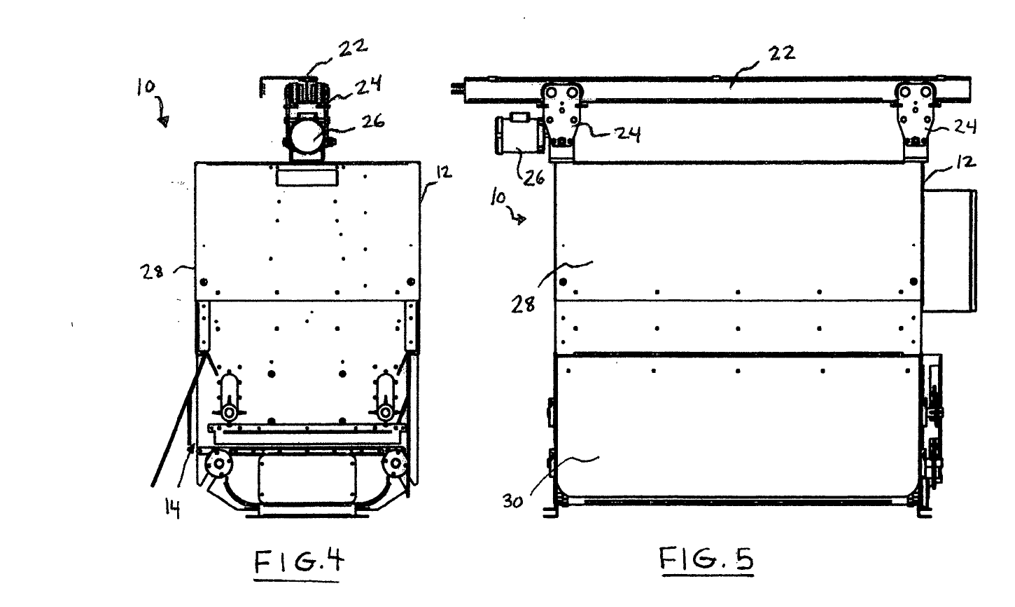

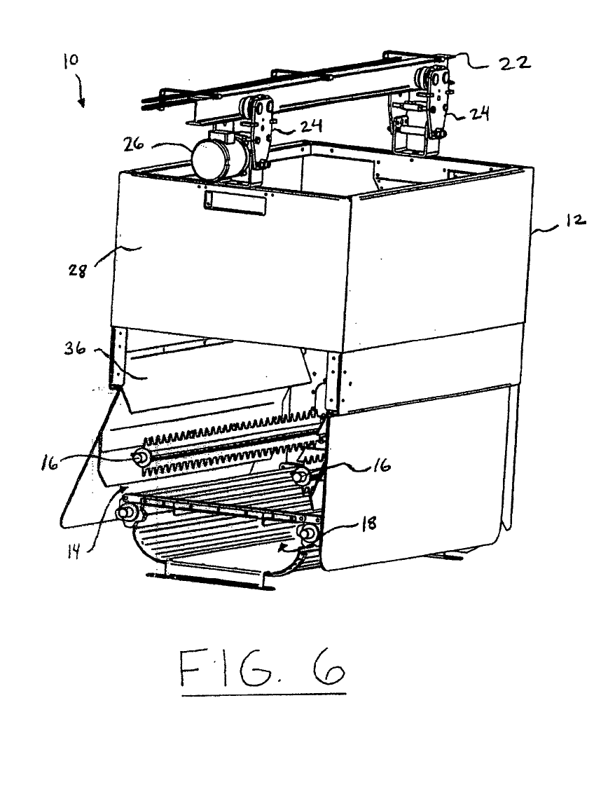

Referring to FIGS. 1 to 6, there is shown a forage distributor 10 for delivering of forage to livestock at a controlled rate, according a preferred embodiment of the present invention. The forage distributor 10 has a hopper 12 for receiving forage. The hopper 12, as shown for example in FIG. 2, has at least one lateral opening 14 in a side wall of the hopper 12 and adjacent to a bottom of the hopper 12 for allowing the forage to exit therefrom. The forage distributor 10 also has at least one rotary mixer 16 extending inside of the hopper 12 for guiding the forage towards the at least one lateral opening. The forage distributor 10 also has a forage conveyor mechanism, such as for example an endless chain conveyor or a conveyor belt bridge 18, for carrying the forage towards the lateral opening 14. The chain conveyor or conveyor belt bridge 18 may take the form of two spaced chains with transverse bars. The forage conveyor is positioned below the rotary mixer 16 and adjacent to the bottom of the hopper 12. The forage distributor 10 also has a driving mechanism, which is operationally connected to the rotary mixer 16 and the forage conveyor for rotating the rotary mixer 16 and moving the forage conveyor towards the lateral opening 14. The forage distributor also has control system for controlling power provided to the driving mechanism to regulate speeds of the rotary mixer 16 and the forage conveyor. The forage distributor 10 also has a moving mechanism, which is operatively connected to the hopper 12 for moving the hopper along a path extending in front of the livestock.

The forage distributor 10 is preferably hung under an overhead electric rail 22 by means of a carriage 24 and uses an electric motor 26 for automatically moving the forage distributor 10 along the path under which animals are fed with forage. Typically, the forage distributor 10 can reach speeds of up to 50 ft/min and the speed can be automatically adjusted.

It should be noted that the forage distributor can also be put on a trailer and pulled by a tractor vehicle. Alternatively, it could have an internal traction motor and ground engaging wheels so as to be driven by a user. As will be apparent to those skilled in the art, many other ways of moving the forage distributor along the path may be used according to different needs to achieve the same result.

The hopper 12 preferably has an open top for easily loading the forage therein. The forage may have been previously mixed in another machine so as to achieve an appropriate mix of feed substances that are distributed to the animal. The hopper 12 has preferably four solid side walls forming a rectangle. Of course, the hopper 12 may take other shapes and forms, which would be readily apparent to those skilled in the art. The lateral opening 14 is adjacent to the bottom of the hopper 12 and extends longitudinally on a side allowing livestock to eat the forage that falls through the opening 14 when the forage distributor 10 is functioning.

Preferably, inside the hopper 12, there are several internal deflectors 36 for diminishing the pressure weight of the forage on the mixers 16. The deflectors 36 also prevent the forage from falling down through any openings of the forage distributor 10 when the mixers 16 and conveyor mechanism are not in operation or standstill. The deflectors 36 are longitudinal plates positioned at an angle with respect to the inner side walls 28 of the hopper 12. The deflectors 36 have roughly the same length as the hopper 12.

Preferably, the hopper 12 has two opposite lateral openings 14 for dumping forage on two sides thus allowing distribution of the forage to livestock on two opposite sides of the forage distributor 10. The hopper 12 may also have two opposite lateral banging doors 30 positioned to cover the corresponding two lateral openings 14. The banging doors 30 may have the same longitudinal measurement as the hopper 12 so that the forage is dumped on the entire length of the hopper 12. In operation, each banging door 30 is forced to open when the forage comes out through the opening 14. Also, the banging doors 30 prevent the animals from reaching the forage inside the hopper 12. In this way the quantity of forage distributed to each animal may be more easily dosed.

Preferably, the forage distributor 10 has two rotary mixers 16 extending inside of the hopper 12. Each rotary mixer 16 is vertically adjustable within a channel 32 in the hopper 12. The mixers 16 are located adjacent to the opposite side walls where the corresponding openings 14 are located. The mixers 16 are rotatably mounted onto the other two opposite side walls 28. The axis of rotation of the mixers 16 is parallel to the path of travel of the forage distributor 10. The axis of rotation of the conveyor mechanism is also parallel to the path of the travel of the forage distributor 10. Both the mixers 16 and conveyor mechanism rotate in the same direction so that forage comes out from one lateral opening 14 at a time. Therefore, the discharge of the forage is effected to either to the left or to the right of the forage distributor 10, depending on the direction of rotation of the mixers and conveyor mechanism.

Advantageously, the mixers 16 avoid the compaction of the forage by providing an adequate pressure on the forage and ensure that a constant output rate of forage distribution is achieved.

Preferably, referring to FIGS. 1 to 3, the driving mechanism of the forage distributor 10 includes an electrical motor 20 connected to a gear box set 21 via a chain drive belt 23, which is trained about several gears that are operatively connected to the mixers 16 and conveyor mechanism or conveyor belt bridge 18. In this way the rotational speed of the mixers 16 can be adjusted independently of the moving speed of the conveyor mechanism or belt bridge 18.

Preferably, the chain drive belt 23 is trained about two conveyor gears 25 operatively connected to the conveyor belt bridge 18 and to two mixer gears 27 operatively connected the corresponding rotary mixers 16, and to a vertically adjustable gear 29 that allows to further adjust relative rotation speed between the two mixers 16 and the conveyor belt bridge 18.

Preferably, the control system of the forage distributor 10 for controlling the power provided to the driving mechanism to regulate the speeds of the rotary mixers 16 and the forage conveyor includes a command box 34, which is mounted on the side of the forage distributor 12. Of course, the command box 34 can also control the moving mechanism for adjusting the speed of the forage distributor 10 along the path.

In use, the mixers 16 regulate the dumping debit by preventing compaction of the forage and also by controlling the debit thereof. The mixers 16 typically turn on themselves twice as fast as the conveyor mechanism or belt bridge 18. Preferably, the conveyor bridge 18 runs from 0 to 45 ft/min, while the mixer 16 runs from 0 to 40 turns/min. Obviously, as those skilled in the art will understand, different speeds may be selected depending on particular needs. Power requirements may change depending on the size of the hopper 12. Typically, the power of the electrical motors range from 1 hp to 3 hp.

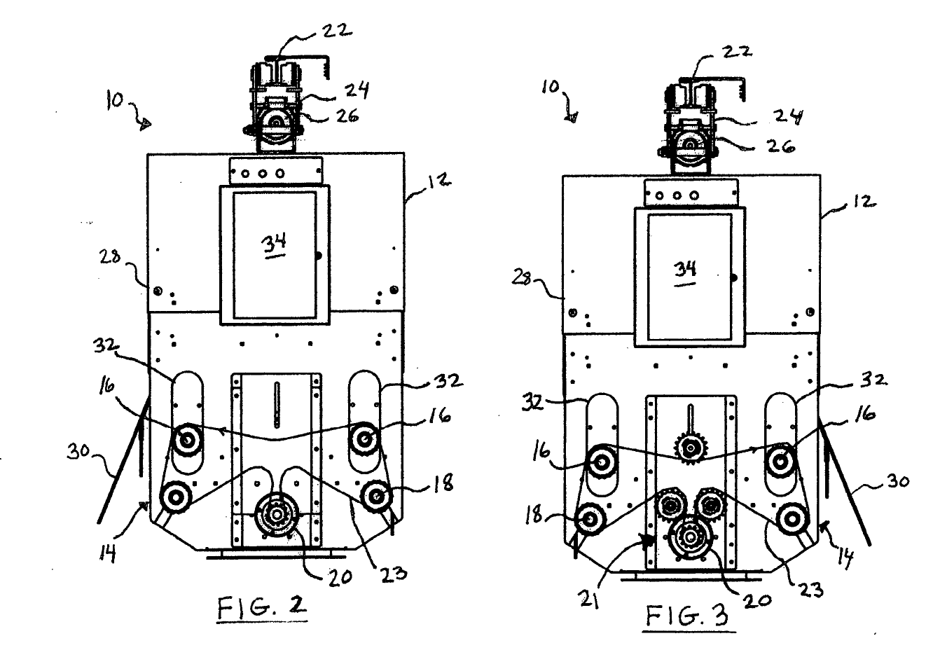

For example, referring to FIG. 2, the drive belt 23 is rotated in an anti-clockwise direction as depicted by the arrow and the forage is forced to come out of the left side of the forage distributor 10, through the opening 14 as the banging door 30 is forced to open. Referring to FIG. 3, the drive belt 23 is rotated in a clockwise direction as shown by the arrow and this will force the forage to come out of the right side of the forage distributor 10 through the opening 14 as the banging door 30 is forced to open.

The forage distributor of the present invention allows for the dumping debit or rate to be continuous from the beginning to the end of the distribution and can be more precisely controlled, which is very important for the distributor automation.

Although preferred embodiments of the present invention have been described in detail herein and illustrated in the accompanying drawings, it is to be understood that the invention is not limited to these precise embodiments and that various changes and modifications may be effected therein without departing from the scope or spirit of the present invention.

1. A forage distributor for delivering of forage to livestock at a controlled rate, comprising:
a hopper for receiving forage, the hopper having at least one lateral opening in a side wall of the hopper and adjacent to a bottom of the hopper for allowing the forage to exit therefrom;
at least one rotary mixer extending inside of the hopper for guiding the forage towards the at least one lateral opening;
forage conveyor means for carrying the forage towards the at least one lateral opening, the forage conveyor means being positioned below the at least one rotary mixer and adjacent to the bottom of the hopper;
driving means operationally connected to the at least one rotary mixer and the forage conveyor means for rotating the at least one rotary mixer and moving the forage conveyor means towards the at least one lateral opening;
control means for controlling power provided to the driving means to regulate speeds of the at least one rotary mixer and the forage conveyor means; and
moving means operatively connected to the hopper for moving the hopper along a path extending in front of the livestock.

2. The forage distributor according to claim 1, wherein the hopper comprises two opposite lateral openings for distributing forage on two sides of the forage distributor at a time.

3. The forage distributor according to claim 2, wherein the hopper comprises two opposite lateral banging doors positioned to cover the two corresponding lateral openings, each banging door being forced to open as the forage is pushed out of the lateral opening during operation.

4. The forage distributor according to claim 3, wherein the hopper comprises two rotary mixers extending inside of the hopper, each rotary mixer being vertically adjustable within a corresponding channel in the hopper.

5. The forage distributor according to claim 1, wherein the moving means include a carriage connected to the hopper to operatively engage with an overhead rail, and an electrical motor for moving the hopper along the overhead rail.

6. The forage distributor according to claim 1, wherein the hopper comprises at least one internal deflector located above the at least one mixer for diminishing weight pressure on the at least one mixer and for preventing forage from falling out the opening when the at least one mixer and conveyor means are standstill.

7. The forage distributor according to claim 1, wherein the forage conveyor means comprise a conveyor belt bridge pivotally connected to two opposite side walls of the hopper.

8. The forage distributor according to claim 7, wherein the driving means comprise an electrical motor connected to a gear box set through a chain drive belt, the chain drive belt being trained about at least one conveyor gear operatively connected to the conveyor belt bridge and to at least one mixer gear operatively connected the at least one rotary mixer.

9. The forage distributor according to claim 7, wherein the hopper comprises two opposite lateral openings for distributing forage on two sides of the forage distributor at a time.

10. The forage distributor according to claim 9, wherein the hopper comprises two opposite lateral banging doors positioned to cover the two corresponding lateral openings, each banging door being forced to open as the forage is pushed out of the lateral opening during operation.

11. The forage distributor according to claim 10, wherein the hopper comprises two rotary mixers extending inside of the hopper, each rotary mixer being vertically adjustable within a corresponding channel in the hopper.

12. The forage distributor according to claim 11, wherein the driving means comprise an electrical motor connected to a gear box set through a chain drive belt, the chain drive belt being trained about two conveyor gears operatively connected to the conveyor belt bridge and to two mixer gears operatively connected the corresponding rotary mixers, and to a vertically adjustable gear that allows to further adjust relative rotation speed between the two mixers and the conveyor belt bridge.
